(19) United States
(12) Patent Application Publication
(10) Pub. No.: US 2013/0240457 A1
(43) Pub. Date: Sep. 19, 2013

(54) Feed Dilution System for a Thickener or Settling Tank

(71) Applicant: Timothy J. Laros, Park City, UT (US)

(72) Inventor: Timothy J. Laros, Park City, UT (US)

(73) Assignee: FLSMIDTH A/S, Valby (DK)

(21) Appl. No.: 13/988,525

(22) PCT Filed: Nov. 18, 2011
(86) PCT No.: PCT/US11/61318

§ 371 Date: May 21, 2013

Related U.S. Application Data
(60) Provisional application No. 61/415,899, filed on Nov. 22, 2010.

(51) Int. Cl. B01F 5/06

(52) U.S. Cl. CPC B01F 5/06
USPC 210/738; 366/341; 239/589

(57) ABSTRACT

In a feed dilution system and method for a thickener or settling tank, a feed pipe nozzle has an outlet opening or orifice configured to generate an initial stream of slurry from the feed pipe into an upstream end of a mixing conduit wherein the stream is extended from a first side of the mixing conduit to a substantially opposite second side in a first direction transverse to the mixing conduit so as to enhance entrainment of dilution fluid flow into the slurry stream and concomitantly produce a substantially uniform solids concentration across a stream flowing from the mixing conduit into the feedwell. The outlet opening is generally shaped asymmetrically towards a third side of the mixing conduit in a second direction transverse to the mixing conduit so as to bias the initial stream of slurry towards the one side, where the second direction is substantially perpendicular to the first direction.

### BACKGROUND OF THE INVENTION

This invention relates to thickener/clarifier settling tanks used to separate liquid and solid components of an influent feed slurry and specifically relates to feedwell apparatus employed in such thickener/clarifiers to enhance the clarification process. More specifically, the invention relates to a feed dilution system and method that delivers a diluted solids slurry to a feedwell of a thickener or clarifier tank.

Thickener/clarifier tanks are used in a wide variety of industries to separate influent feed slurry comprising a solids, or particulate, containing fluid to produce a “clarified” liquid phase having a lower concentration of solids than the influent feed slurry and an underflow stream having a higher concentration of solids than the influent feed slurry. Thickener/clarifier tanks conventionally comprise a tank having a floor and a continuous wall, which define a volume within which the clarification process takes place. Thickener/clarifier tanks also include an influent feed pipe for delivering influent feed to the tank, an underflow outlet for removing settled solids from the tank and a fluid discharge outlet for directing clarified liquid away from the tank. Thickener/clarifier settling tanks may also include a rake assembly having rake arms for sweeping along the floor of the tank, and may include an overflow launder or bustle pipe for collecting clarified liquid near the top of the tank.

Thickener/clarifier tanks of the type described operate by introducing an influent feed stream into the volume of the tank where the influent is retained for a period long enough to permit the solids to settle out by gravity from the fluid. The solids that settle to the bottom of the tank produce a sludge bed near the bottom of the tank, which is removed through the underflow outlet. Clarified liquid is formed at or near the top of the thickener/clarifier tank and is directed away from the tank for further processing or disposal. Settling of solids may be enhanced in some applications by the addition of a flocculent or polymer that forms agglomerates that settle more readily. In many applications, an objective of fluid clarification is to enhance the settling process to achieve a high throughput of solids, and thereby enhance solids recovery.

Many thickener/clarifier tanks are constructed with a feedwell, usually centrally located within the tank, into which the influent feed stream is delivered. The feedwell generally serves the purpose of reducing the fluid velocity of the incoming influent feed stream so that the energy in the stream may be dissipated to some degree before entering the tank. Dissipation of energy in the influent feed stream lessens the disruptive effect that the incoming influent feed has on the settling rate of the solids in the tank. In other words, introduction into a thickener/clarifier of an influent feed stream under high fluid velocity tends to cause turbulence in the tank and compromises the settling rate of solids. A feedwell may be structured in a variety of ways, therefore, to create or enhance dissipation of energy in the influent feed. For example, the feedwell and influent feed pipe may be structured to introduce influent feed to the feedwell at two opposing directions and into an annular space, such as is disclosed in U.S. Pat. No. 4,278,541 to Eis, et al.

In many feedwell assemblies, the influent feed pipe is incorporated into a dilution feed system including a mixing conduit with a downstream end connected to the feedwell and an upstream end that receives both a slurry stream from a feed pipe and a diluting liquid. The feed pipe is provided at its outlet end with a nozzle usually having a circular outlet opening located proximate the upstream end of the mixing conduit.

The mixing conduit may take the form of a classical submerged pipe or tube or alternatively an open channel form in which a mixing zone is open to the atmosphere. It has been observed that mixing of the incoming solids slurry with thickener overflow or dilution liquor may be less complete or effective in the open channel design. It has been observed further that the dilution liquor stream flows along the wall of the mixing channel, outside of the concentrated slurry jet from the feed pipe nozzle, and only partially mixes with the concentrated slurry jet. This type of performance is not ideal for a feed slurry dilution device that is mixing flocculant with a diluted slurry prior to entering a gravity thickener. In a best case scenario, a combined slurry stream entering the thickener or feedwell should be diluted to a very uniform concentration of solids across the entire cross-sectional area of the open channel.

### OBJECTS OF THE INVENTION

It is an object of the present invention to provide an improved feed dilution system and method for a feedwell assembly of a thickener/clarifier/settling tank.

A more specific object of the present invention is to provide such a feed dilution system and method which provides a substantially uniform solids distribution across the cross-section of a feed stream entering a feedwell.

Another specific object of the present invention is to provide such a feed dilution system and method which produces an improved or enhanced mixing of an incoming slurry with a flocculent.

These and other objects of the present invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

Applicant's have discovered that if the motive jet, that is, the output stream of the feed pipe nozzle, is non-circular and flatter and thus broader across the width of the open channel instead of a tubular stream flowing down the center of the mixing channel, the motive flow is more conducive to mixing the solids and dilution fluids together in an area closer to the dilution-liquid suction inlet of the mixing channel and that the flows are better mixed prior to the exit from the mixing channel, hence producing a more uniform solids concentration over the entire open channel as it enters the feedwell.

While a nozzle with a planar or rectangular output opening produces a widening or flattening of the inlet motive jet and enhances slurry dilution and better utilization of the dilution liquor to provide better and/or less flocculant consumption, a nozzle having an outlet opening with a modified cruciform configuration yields even better results. Preferably, the upper arm of the cross-shaped configuration is reduced in length relative to the lower leg, thereby directing the flow more downwardly as well as more across the width of the open channel. Not only is the inlet flow no longer circular but it is distributed even better than in the case of a flat jet entering the mixing channel. With the modified cruciform nozzle, the inlet flow is nearly flat horizontally while having a downward component which serves to better mix the slurry at the bottom of the channel.

It is to be noted that the arms or legs of the nozzle output opening can be of different widths to yield higher or lower velocities in different directions. Likewise, the horizontal arms may have different lengths than both of the vertical arms. The nozzle may be rotatably, variously snap fit, or otherwise mounted to the slurry feed pipe so as to enable adjustment of the orientation of the outlet opening and/or removal and replacement of the same.

A feed dilution system for a thickener or settling tank comprises, in accordance with the present invention, a slurry feed pipe, a nozzle attached to a downstream end of the feed pipe, a mixing conduit, and a feedwell disposed inside the thickener or settling tank. At least a portion of the nozzle is disposed proximate an upstream end of the mixing conduit. A downstream end of the mixing conduit is functionally attached to the feedwell, perhaps at or to its outer wall, so that the mixing conduit communicates with the feedwell. Pursuant to the invention, the nozzle has an outlet opening or orifice configured to generate an initial stream of slurry from the feed pipe into an upstream end of the mixing conduit that is extended from a first side of the mixing conduit to a substantially opposite second side in a first direction transverse to the mixing conduit so as to enhance entrainment of dilution fluid flow into the slurry stream and concomitantly produce a more uniform solids concentration across a stream flowing from the mixing conduit into the feedwell. In addition, the outlet opening is generally shaped asymmetrically towards a third side of the mixing conduit in a second direction generally transverse to the first direction so as to bias the initial stream of slurry towards the one side, where the second direction is substantially perpendicular to the first direction.

In accordance with a further feature of the invention, the outlet opening of the nozzle is symmetric about an axis extending along the second direction and asymmetric about an axis extending along the first direction. In various embodiments of the invention, the outlet opening of the nozzle has a pair of first arms or legs that are disposed symmetrically on opposite sides of the axis of symmetry and extend at least partially in the first direction, the outlet opening having at least one second arm extending at least partially in the second direction and disposed on one side of the first arms, towards the third side.

In one embodiment of the invention, the outlet opening of the nozzle has a cruciform shape. The cruciform shape may comprise multiple arms (or legs) extending away from a node or junction. The arms include two first arms extending away from one another on opposite sides of the node or junction along the first direction, and further include at least one second arm extending away from the node or junction on one side of the first arms in the second direction. The cruciform shape may also include an additional second arm extending away from the at least one second arm on a side of the node or junction opposite the at least one second arm, where the additional second arm is generally substantially shorter than the at least one second arm.

In various orientations of the nozzle about a flow axis, the first arms and the first direction are at least approximately horizontal, while the second arms constitute lower and upper arms of the cruciform shape. The length of the upper or additional second arm is typically less than one-half the length of the lower second arm.

In preferred embodiments of the invention, the nozzle outlet opening has exactly one axis of symmetry, with at least a portion of the lower second arm extending along the axis of symmetry.

The first arms are typically at least approximately of equal lengths.

In one embodiment of the present invention, the first arms are collinear with one another, and the second arms are collinear with one another.

The nozzle may be rotatably, snap fit, bolted, or otherwise mounted to the feed pipe and it may be removable and/or replaceable.

The mixing conduit may take any number of forms, including that of an open or closed channel having a substantially rounded, v-shaped, rectangular or approximately rectangular cross-section with one or more sharp or rounded lower corners. The outlet opening of the nozzle is asymmetrically configured to bias the initial stream to remove settled particles from the corners of the mixing conduit.

In accordance with the present invention, a nozzle disposable at a downstream end of a feed pipe in a feed dilution system for a thickener or settling tank comprises a nozzle body having an inlet end and an outlet end, the outlet end being provided with an outlet opening or orifice having a configuration that may be symmetric about an axis and asymmetric about all lines extending perpendicular to the axis.

The outlet opening of the nozzle may have multiple arms extending away from a node or junction, the arms including two first arms extending away from one another on opposite sides of the axis, the arms including at least one second arm extending away from the node or junction at least partially parallel to the axis.

The arms may include an additional second arm extending away from the at least one second arm on a side of the node or junction opposite the at least one second arm and at least partially parallel to the axis, the additional second arm being substantially shorter than the at least one second arm, the first arms being at least approximately of equal lengths.

In one embodiment of the present invention, the nozzle outlet opening has a strictly cruciform configuration wherein the first arms are collinear with one another about a first axis, and the second arms are collinear with one another and extend along a second axis. In this cruciform configuration, the outlet opening takes the form of a cross having a linear main branch and a linear cross-branch extending substantially perpendicularly to one another, the main branch having a first segment on one side of the cross branch and a second segment on an opposite side of the cross branch, the cross branch being disposed substantially closer to one end of the main branch than to an opposite end thereof, so that the first segment is substantially shorter than the second segment. The main branch typically but not necessarily bisects the cross branch.

The nozzle outlet opening typically has exactly one axis of symmetry, generally vertical, with at least a portion of the at least one second arm extending along that axis. However, in another embodiment of the present invention, the nozzle opening is generally tri-lobed, and may be variously oriented for the desired flow and mixing effect. Furthermore, the general term nozzle outlet or orifice also includes one or more, i.e., multiple openings, which may be sized, configured and arranged in various ways and configurations in order to produce the same enhanced mixing and other effects as the apparatus and methods disclosed and shown herein. Additionally, the general term nozzle outlet or orifice also includes an opening or openings which may be formed by the shape of the outer wall of the nozzle outlet or orifice. Furthermore, the shape of the end of the slurry feed pipe itself may actually form the so-called nozzle and/or outlet/opening of the feed pipe orifice.

The present invention also includes and describes a method of conditioning the slurry feed stream flowing into the feedwell of a thickener/clarifier or settling tank which is used as described and disclosed herein to enhance the entrainment of dilution fluid with the slurry feed stream, reduce the settling of solids in the mixing conduit, and generally enhance the mixing action therein. The method may further include the steps of educting the dilution liquid, perhaps from the tank itself, into the mixing conduit by way of momentum transfer responsive to the influent slurry feed stream, flocculating a resulting diluted slurry feed stream, and/or producing a substantially uniform solids concentration in the slurry feed stream across the width and depth of the mixing conduit as the slurry feed stream enters the feedwell.

A feedwell feed dilution system, method and associated nozzle opening or orifice in accordance with the present invention generally improves mixing in the mixing conduit. This is of particular benefit in generally rectangular open-channel type mixing conduits where the invention results not only in a more even or uniform distribution of solids across the stream entering the feedwell from the mixing conduit but also serves to prevent a buildup of particles along the lower corners of the mixing conduit.

### BRIEF DESCRIPTION OF THE DRAWING

FIG. 1 is a vertical sectional view of a thickener/clarifier tank having a center pier supporting a rotating sludge raking structure and a feedwell assembly with a feed dilution system in accordance with the present invention.

FIG. 2 is a plan view of the thickener/clarifier tank of FIG. 1, taken on line II-II in FIG. 1.

FIG. 3 is a schematic perspective view of a feedwell assembly with a feed dilution system in accordance with the present invention.

FIG. 4 is a schematic vertical cross-sectional view of the feed dilution system of FIG. 3.

FIG. 5 is an end elevational view of a nozzle included in the feed dilution system of FIGS. 1-4, showing a nozzle outlet opening in accordance with the invention.

FIG. 6 is an end elevational view similar to FIG. 5, depicting another nozzle outlet opening in accordance with the invention.

FIG. 7 is a view similar to FIGS. 5 and 6, depicting a further nozzle outlet opening in accordance with the invention.

FIG. 8 is a view similar to FIGS. 5-7, depicting yet another nozzle outlet opening pursuant to the invention.

FIG. 9 is a view similar to FIGS. 5-8, depicting still another nozzle outlet opening pursuant to the invention.

### DETAILED DESCRIPTION

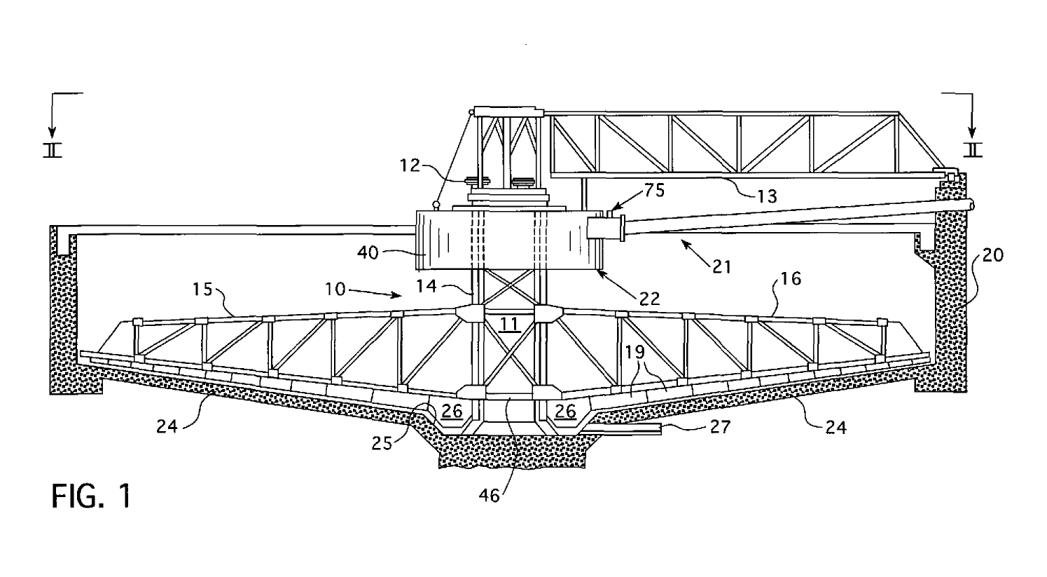

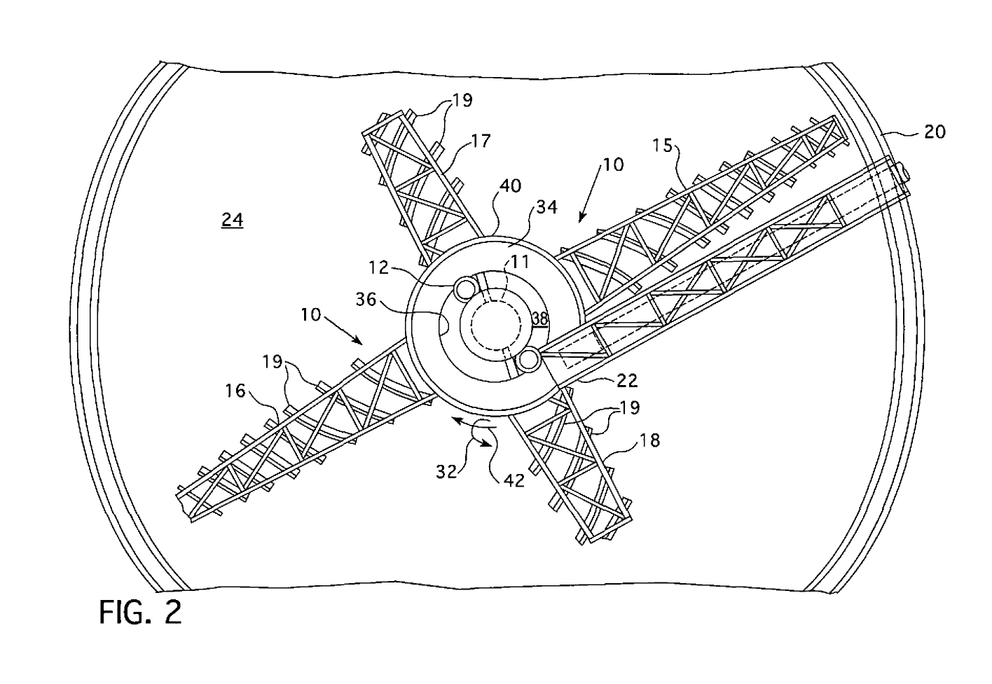

As illustrated in FIGS. 1 and 2, a thickener/clarifier comprises a continuously operating thickening/settling tank 20 wherein a sludge raking structure 10 is supported for rotation upon a center pier 11. A drive mechanism 12 of any suitable known construction is mounted atop the pier providing the driving torque for the rake structure. The pier also supports the inner end of an access bridge 13.

Rake structure 10 comprises a central vertical cage portion or cage 14 surrounding the pier 11, and rake arms of girder like construction extending rigidly from the cage. Rake structure 10 has one pair of long rake arms 15 and 16 opposite to one another, and a pair of short rake arms 17 and 18 disposed at right angles thereto, all arms having sludge impelling or conveying blades 19 fixed to the underside thereof.

Rake structure 10 operates in a settling tank 20 to which a feed suspension or feed pulp is supplied through a feed dilution system 21 terminating in a cylindrical feedwell body 22 which surrounds the top end portion of the rake structure and is supported by pier 11.

Tank 20 may be of usual construction, comprising a bottom 24 of shallow inverted conical inclination, and formed with an annular sump 25 around the pier, to which settled solids or sludge are conveyed by rake structure 10. Scraper blades 26, unitary with rake structure 10 and substantially conforming to the profile of sump 25, move the collected sludge to a point of delivery from the sump, as by way of a discharge pipe 27.

Feed dilution system 21 is connected at a downstream end to feedwell body 22. Feedwell body 22 has an annular floor panel 34 (FIG. 2) with an inner edge 36 defining a circular opening 38 and an outer edge contiguous with a cylindrical sidewall 40 of the feedwell body. Feed dilution system 21 is connected to feedwell body 22 so as to deliver slurry stream 42 to flow along a circular path inside the feedwell body. Slurry stream 42 has a substantially circular inner boundary located generally above inner edge 36 and a substantially circular outer boundary located adjacent feedwell sidewall 40. The inner and outer boundaries extend parallel to the path of the incoming slurry stream 42.

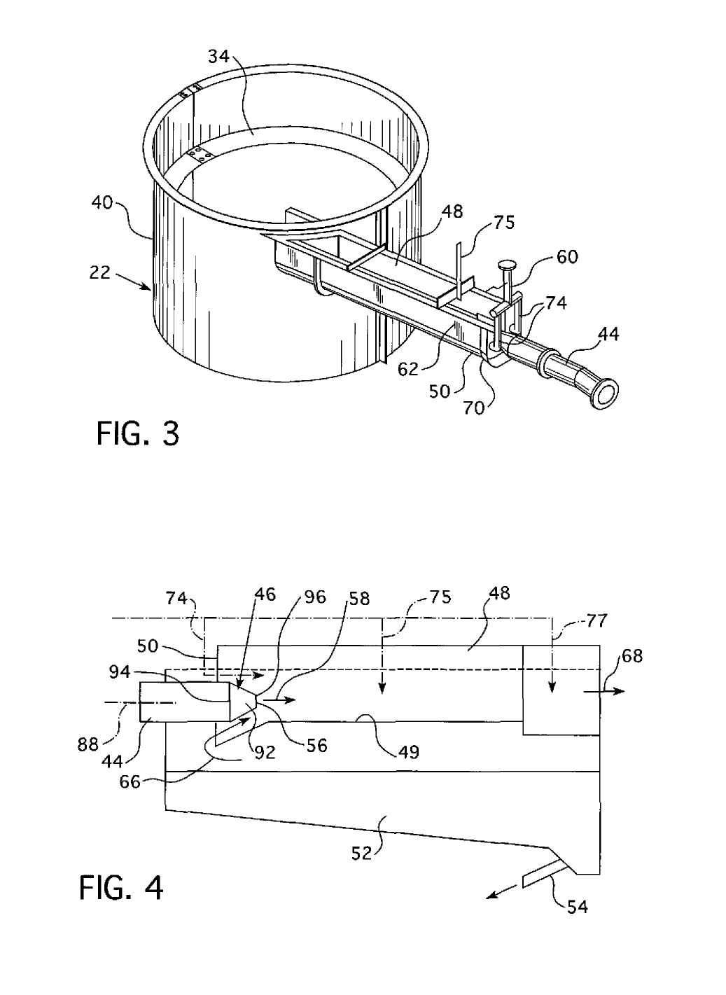

As depicted in FIG. 3 and more schematically in FIG. 4, feed dilution system 21 includes a slurry feed pipe 44, a nozzle 46 attached to a downstream end of the feed pipe, and a mixing conduit 48 in the form of an open channel having lower corners 49 (only one shown). Feed dilution system 21 may be defined to further include feedwell body 22. At least a portion of nozzle 46 is disposed proximate an upstream end 50 of mixing conduit 48. A downstream end of mixing conduit 48 is functionally attached to feedwell sidewall 40 so that the mixing conduit communicates with the feedwell. In FIG. 4, reference designation 52 represents a bed of settled solids in settling tank 20, pipe 54 being provided for removing the thickened underflow.

Nozzle 46 (FIG. 4) generally comprises a nozzle body 92 having an inlet end 94 and an outlet end 96, the outlet end being provided with outlet opening or orifice 56.

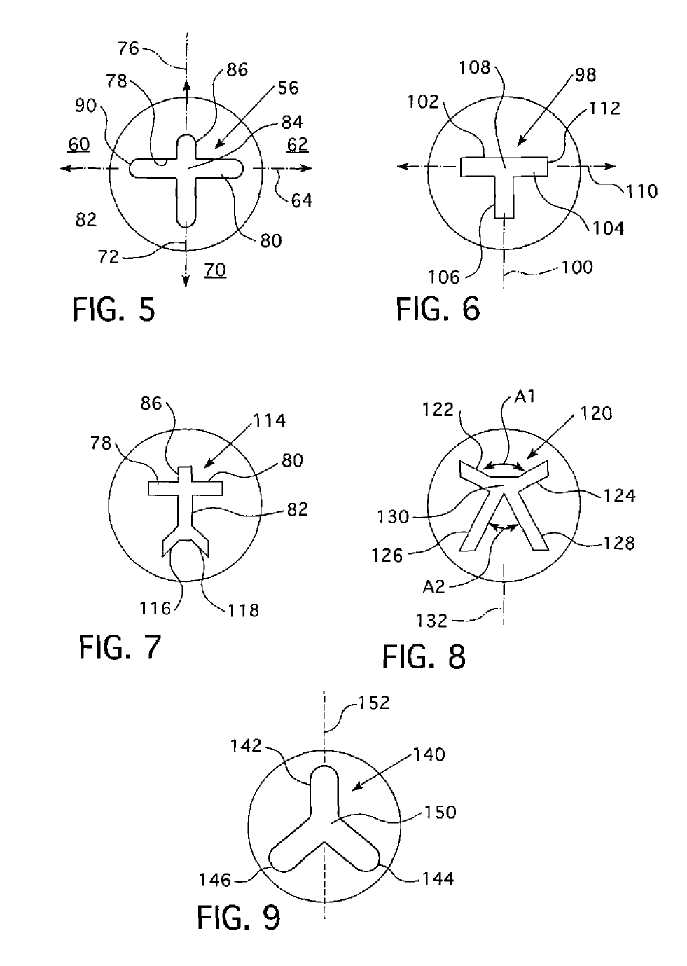

As shown in FIG. 5, nozzle 46 may have a cruciform outlet opening 56 configured to generate an initial stream 58 (FIG. 4) of slurry from feed pipe 44 into upstream end 50 of mixing conduit 48 that is extended from a first side 60 of the mixing conduit to a substantially opposite second side 62 in a first direction 64 transverse to the mixing conduit so as to enhance entrainment of dilution fluid or supernatant flow 66 (FIG. 4) into the slurry stream 58 and concomitantly produce a substantially uniform solids concentration across a stream 68 flowing from the mixing conduit into feedwell body 22. Outlet opening 46 is shaped asymmetrically towards a third side 70 of mixing conduit 48 in a second direction 72 transverse to the mixing conduit so as to bias the initial stream 58 of slurry towards the third side 70, where the second direction 72 is substantially perpendicular to the first direction 64.

Flocculent may be delivered via a tube or tubes 74 into the dilution fluid or supernatant flow 66 at upstream end 50 of mixing conduit 48 and additionally at points 75, 77 further downstream along the mixing conduit, now including both the slurry feed stream and dilution fluid.

As further shown in FIG. 5, outlet opening 56 of nozzle 46 is substantially symmetric about an axis 76 extending along the second direction 72 and asymmetric about all lines extending parallel to the first direction 64. The term “substantially symmetric” is used herein to denote a degree of symmetry that produces balanced mixing from one side to an opposite side across the mixing conduit 48. This term is intended to encompass variations in arm length that are measurable on a linear scale but do not result in asymmetric flow patterns.

Outlet opening 56 has a pair of first arms or legs 78, 80 that are disposed symmetrically on opposite sides of axis 76 and extend in the first direction 64. Outlet opening 56 also has a second arm or leg 82 extending in the second direction 72 and disposed on a lower side of arms 78, 80 towards the third side 70 of mixing conduit 48.

Nozzle outlet opening 56 particularly has a cruciform shape wherein the multiple arms (or legs) 78, 80, 82 extend away from a node or junction 84. Arms 78 and 80 are collinear with one another, of equal width and are disposed on opposite sides of node or junction 84 along direction 64. Arm or leg 82 may be of the same width (or not) as arms 78, 80 and extends away from node or junction 84 on one side of arms 78, 80 in direction 72. Outlet opening 56 also includes an additional second arm 86 extending away from node or junction 84 on a side thereof opposite arm 82 and collinearly with arm 82. This additional second arm 86, preferably collinear with arm 82, is substantially shorter than arm 82 and is no more than about one-half the length of arm 82.

Nozzle 46 may be variously mounted to feed pipe 44 for rotation about a longitudinal flow axis 88 so as to enable an adjustment in the angular orientation of opening 56 or removal and replacement thereof. Generally, lower arm or leg 82 and upper arm or leg 86 are oriented vertically, while arms 78, 80 are horizontal. However, one might rotate nozzle 46 to as to provide some deviation in outlet opening orientation from the vertical. Accordingly, in some orientations of nozzle 46 about longitudinal flow axis 88, arms 78 and 80 and direction 64 are at least approximately horizontal, with arms 82 and 86 constituting lower and upper arms of the cruciform shape.

Nozzle outlet opening 56 has exactly one axis of symmetry 76, with lower arm 82 extending along that axis. Arms 78 and 80 are at least approximately of equal lengths. While ends 90 of the various arms 78, 80, 82, 86 have arcuate edges, the ends may alternatively take a flat or linear form (compare FIGS. 6-8).

Outlet opening 56 takes the form of a cross having a linear main branch formed by arms 82 and 86 and a linear cross-branch consisting of arms 78 and 80 (and node or junction 84), the main branch and the cross-branch extending substantially perpendicularly to one another. Arms 78 and 80 constitute branch segments on opposite sides of the cross branch. The cross branch is disposed substantially closer to one end of the main branch than to an opposite end thereof, so that the upper segment, arm 86, is substantially shorter than the lower segment, arm 82. The main branch typically but not necessarily bisects the cross branch.

It is to be noted that the asymmetrical configuration of outlet opening 56, with the biasing of the flow downwardly owing to the larger size of arm 82, serves to remove settled particles from the corners of open channel conduit 48. It is surmised that a higher velocity or turbulence is created, which lifts particles away from the bottom of the mixing conduit 48 for entrainment with the diluted slurry stream.

FIG. 6 shows an alternative outlet opening 98 for nozzle 46, having a configuration that is substantially symmetric about an axis 100 and asymmetric about all lines extending perpendicular to said axis. Opening 98 has multiple arms 102, 104, 106 extending away from a node or junction 108. Arms 102, 104 extend collinearly in a first direction 110 on opposite sides of axis 100. Arm 105 extends away from node or junction 108 parallel to and collinear with axis 100. Arms 102 and 104 define a first branch of the approximately cruciform outlet opening 98, while arm 106 constitutes a second branch that substantially bisects the first branch.

Like nozzle opening 56, outlet opening 98 is configured to generate an even or uniform distribution of solids in the exit slurry stream 68 and to entrain particles in a lower portion of the mixing conduit 48 to prevent accumulation of the particles particularly in the corners of the conduit. Arms 102, 104, 106 have straight ends 112 but may have arcuate or curved end edges as shown in FIG. 5.

As illustrated in FIG. 7, another outlet opening 114 for nozzle 46 has a substantially cruciform configuration that is a modification of outlet opening 56 of FIG. 5. Opening 114 has been modified to include a pair of fingers or extensions 116 and 118 angled away from one another at a free end of arm 82.

Like nozzle openings 56 and 98, outlet opening 114 is configured to generate an even or uniform distribution of solids in the exit slurry stream 68 and to entrain particles in a lower portion of the mixing conduit 48 to prevent accumulation of the particles particularly in the corners of the conduit. Arms 78, 80, 82 and 86 are shown in FIG. 7 as having linear rather than arcuate extremities.

FIG. 8 depicts a further alternative outlet opening 120 for nozzle 46, that has a modified X configuration with a pair of arms 122, 124 and a pair of legs (or lower arms) 126, 128 connected to one another at a node or junction 130. Outlet opening 120 has an axis of symmetry 132 and is asymmetric about any line extending perpendicular to the axis, in the plane of the opening. Arms 122, 124 are of substantially equal lengths and extending at a first angle A1 relative to one another. Legs 126, 128 are of substantially equal lengths and extending at a second angle A2 relative to one another. Angle A1 is significantly larger than angle A2.

FIG. 9 depicts yet another alternative outlet opening 140 for nozzle 46 that has a three-armed or tri-lobed configuration with three arms or lobes 142, 144 and 146 extending from a, possibly centrally located, node or junction 150. Outlet opening 140 has an axis of symmetry 152 and is asymmetric about any line extending perpendicular to the axis, in the plane of the opening. The lobes 142, 144 and 146 as shown are of substantially equal lengths and dimensions, and angularly substantially equally displaced about node or junction 150. Of course, variations in their respective sizes and/or angular locations could be made in order to improve their effectiveness in entraining and mixing particles in the mixing conduit 48 and thus the exit slurry stream 68.

The present invention further includes a method of conditioning a slurry feed stream flowing into the feedwell of a thickening or settling tank, said tank including a tank inlet system comprising an influent slurry feed pipe, nozzle and orifice directing the influent slurry feed stream into a mixing conduit, said mixing conduit including a bottom and leading to the feedwell, said method, for example, using the apparatus as shown in various of the accompanying FIGS. 1-9.

This method would include the steps of flowing the influent slurry feed stream through the feed pipe, nozzle and orifice into the mixing conduit, using the nozzle orifice to shape the influent slurry feed stream in order to enhance the entrainment of dilution fluid with the influent slurry feed stream and also to bias at least a portion of the influent slurry feed stream towards the bottom of the mixing channel in order to reduce the settling of solids and enhance the mixing action in the mixing channel, thereby forming a diluted and well mixed slurry feed stream, and flowing the resulting diluted and mixed slurry feed stream into the feedwell.

The method could also include the additional steps of educting the flow of the dilution fluid into the mixing channel by way of using the transfer of momentum between the influent slurry feed stream and the dilution fluid, flocculating the incoming dilution fluid and/or the slurry feed stream and the dilution fluid within the mixing channel, and/or producing a substantially uniform solids concentration within the resulting diluted and mixed slurry feed stream flowing into the feedwell.

Although the invention has been described in terms of particular embodiments and applications, one of ordinary skill in the art, in light of this teaching, can generate additional embodiments and modifications without departing from the spirit of or exceeding the scope of the claimed invention. It is believed that the invention is useful in virtually any type of feedwell assembly, with or without the addition of flocculent, with or without slurry dilution by eduction, with singular or multiple infeed paths, with or without spill lips (i.e., annular bottom panels or shelves in the feedwell bodies), etc. Accordingly, it is to be understood that the drawings and descriptions herein are proffered by way of example to facilitate comprehension of the invention and should not be construed to limit the scope thereof which is only defined by the broadest possible interpretation of the appended claims and their equivalents.

Furthermore, a contractor or other entity may provide, or be hired to provide, the apparatus and/or method such as those disclosed in the present specification and shown in the figures. For instance, the contractor may receive a bid request for a project related to designing a system for producing a particular slurry feed stream or may offer to design such a method and accompanying system. The contractor may then provide the apparatus and/or method such as those discussed above. The contractor may provide such a method by selling the apparatus and/or method or by offering to sell the apparatus and/or method, and/or the various accompanying parts and equipment to be used with and/or for said method. The contractor may provide a method and/or related equipment that are configured to meet the design criteria of a client or customer. The contractor may subcontract the fabrication, delivery, sale, or installation of a component of, or of any of the devices or of other devices contemplated for use with the method. The contractor may also maintain, modify or upgrade the provided devices and their use within the general method. The contractor may provide such maintenance or modifications by subcontracting such services or by directly providing those services.

1. A feed dilution system for a thickener or settling tank, comprising:
a slurry feed pipe;
a nozzle attached to a downstream end of said feed pipe;
a mixing conduit, at least a portion of said nozzle being disposed proximate an upstream end of said mixing conduit; and
a feedwell disposed inside the thickener or settling tank, a downstream end of said mixing conduit being functionally attached to said feedwell so that said mixing conduit communicates with said feedwell,
said nozzle having an outlet opening configured to generate an initial stream of slurry from said feed pipe into an upstream end of said mixing conduit that is extended from a first side of said mixing conduit to a substantially opposite second side in a first direction transverse to said mixing conduit so as to enhance entrainment of dilution fluid flow into the slurry stream and concomitantly produce a uniform solids concentration across a stream flowing from said mixing conduit into said feedwell, said outlet opening being shaped asymmetrically towards a third side of said mixing conduit in a second direction transverse to said first direction so as to bias said initial stream of slurry towards said third side, said second direction being substantially perpendicular to said first direction.

2. The feed dilution system defined in claim 1 wherein said outlet opening of said nozzle is symmetric about an axis extending along said second direction and asymmetric about all lines extending parallel to said first direction.

3. The feed dilution system defined in claim 2 wherein said outlet opening of said nozzle has a cruciform shape.

4. The feed dilution system defined in claim 3 wherein said outlet opening of said nozzle has multiple arms extending away from a node or junction, said arms including two first arms extending away from one another on opposite sides of said node or junction along said first direction, said arms including at least one second arm extending away from said node or junction on one side of said first arms in said second direction.

5. The feed dilution system defined in claim 4 wherein said arms include an additional second arm extending away from said at least one second arm on a side of said node or junction opposite said at least one second arm, said additional second arm being substantially shorter than said at least one second arm, said first arms being at least approximately of equal lengths.

6-7. (canceled)

8. The feed dilution system defined in claim 2 wherein said outlet opening of said nozzle has a pair of first arms disposed symmetrically on opposite sides of said axis and extending at least partially in said first direction, said outlet opening having at least one second arm extending at least partially in said second direction and disposed on one side of said first arms, towards said third side.

9. The feed dilution system defined in claim 1 wherein said nozzle is rotatably mounted to said feed pipe.

10. The feed dilution system defined in claim 1 wherein said mixing conduit is an open channel having a rectangular cross-section with a pair of lower corners, said outlet opening being asymmetrically configured to bias said initial stream to remove settled particles from said corners.

11. The feed dilution system defined in claim 1 wherein said mixing conduit has a rectangular cross-section with a pair of lower corners, said outlet opening being asymmetrically configured to bias said initial stream to remove settled particles from said corners.

12. A nozzle disposable at a downstream end of a feed pipe in a feed dilution system for a thickener or settling tank, said nozzle comprising a nozzle body having an inlet end and an outlet end, said outlet end being provided with an outlet opening having a configuration that is substantially symmetric about an axis and asymmetric about all lines extending perpendicular to said axis.

13. The nozzle defined in claim 12 wherein said outlet opening of said nozzle has multiple arms extending away from a node or junction, said arms including two first arms extending away from one another on opposite sides of said axis, said arms including at least one second arm extending away from said node or junction at least partially parallel to said axis.

14. The nozzle defined in claim 13 wherein said arms include an additional second arm extending away from said at least one second arm on a side of said node or junction opposite said at least one second arm and at least partially parallel to said axis, said additional second arm being substantially shorter than said at least one second arm, said first arms being at least approximately of equal lengths.

15-17. (canceled)

18. The nozzle defined in claim 12 wherein said outlet opening takes the form of a cross having a linear main branch and a linear cross-branch extending substantially perpendicularly to one another, said main branch having a first segment on one side of said cross branch and a second segment on an opposite side of said cross branch, said cross branch being disposed substantially closer to one end of said main branch than to an opposite end thereof, so that said first segment is substantially shorter than said second segment.

19. The nozzle defined in claim 18 wherein said main branch bisects said cross branch.

20-22. (canceled)

23. A method of conditioning a slurry feed stream flowing into the feedwell of a thickening or settling tank, said tank including a tank inlet system comprising an influent slurry feed pipe and orifice directing the influent slurry feed stream into a mixing conduit, said mixing conduit including a bottom and leading to the feedwell, said method comprising the steps of:
flowing the influent slurry feed stream through the feed pipe and orifice into the mixing conduit;
using the feed pipe orifice to shape the influent feed stream in order to enhance the entrainment of dilution fluid with the slurry feed stream and also to bias at least a portion of the influent slurry feed stream towards the bottom of the mixing channel in order to reduce the settling of solids and enhance the mixing action in the mixing channel, thereby forming a diluted and mixed slurry feed stream; and
flowing the resulting diluted and mixed slurry feed stream into the feedwell.

24. The method of claim 23 further including the step of educting the flow of the dilution fluid into the mixing channel by way of using the transfer of momentum between the influent slurry feed stream and the dilution fluid.

25. The method of claim 23 further including the step of flocculating the entrained dilution fluid.

26. The method of claim 23 further including the step of flocculating the slurry feed stream and the dilution fluid within the mixing channel.

27. The method of claim 23 further including the step of producing a substantially uniform solids concentration within the resulting diluted and mixed slurry feed stream flowing into the feedwell.

28. (canceled)

29. The method of claim 23 wherein the feed pipe shape forms the orifice which in turn shapes the influent feed stream according to the method.
